(19) United States
(12) Patent Application Publication
(10) Pub. No.: US 2008/0298695 A1
(43) Pub. Date: Dec. 4, 2008

(54) MOTION VECTOR DETECTING APPARATUS, MOTION VECTOR DETECTING METHOD AND INTERPOLATION FRAME CREATING APPARATUS

(75) Inventor: Hiroshi Yoshimura, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 12/128,902

(22) Filed: May 29, 2008

(30) Foreign Application Priority Data
May 30, 2007 (JP) 2007-143990

(51) Int. Cl. G06K 9/36

(52) U.S. Cl. 382/236

(57) ABSTRACT

According to one embodiment, a motion vector detecting apparatus performs block matching of a plurality of image frames to detect a motion vector. The motion vector detecting apparatus has a macroblock joining section forming a joined macroblock in which a plurality of macroblocks including repeating images among macroblocks being subjects of the block matching are joined by every motion characteristic of the repeating image included in each macroblock.

### CROSS-REFERENCE TO RELATED APPLICATIONS

This application is based upon and claims the benefit of priority from Japanese Patent Application No. 2007-143990, filed May 30, 2007, the entire contents of which are incorporated herein by reference.

### BACKGROUND

### 1. Field

One embodiment of the invention relates to a motion vector detecting apparatus, a motion vector detecting method and an interpolation frame creating apparatus.

Currently, various apparatuses having an image display device such as televisions, personal computers, and portable telephones are in practical use. In such an apparatus having an image display device, there is applied a technique to create an interpolation frame interpolating each image frame from image frames constituting an input image signal, and interpolate the created interpolation frame between the image frames to display them.

This interpolation frame is created for purposes such as preventing decrease of image quality due to displaying of identical frames in a liquid crystal display apparatus, preventing a motion blur which is caused by a hold type display, and moreover displaying images smoothly using an input image signal transmitted at a low frame rate.

When such an interpolation frame is created, two image frames are divided into predetermined blocks, block matching is performed for obtaining a correlation between blocks in respective image frames, and based on the correlation obtained by the block matching, a motion vector is detected, which shows displacement between blocks having a highest correlation with each other.

Conventionally, regarding detection of such a motion vector, there have been various proposals. For example, in Japanese Patent Application Publication (KOKAI) No. 2000-134628 (Patent document 1), it is disclosed a detecting method of a motion vector in which for neighboring first and second blocks, a search area of the second block is set based on a motion vector detected in the first block and block matching is performed in that set search area to detect a motion vector for the second block.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a configuration of an interpolation frame creating apparatus according to an embodiment of the invention;

FIG. 2 is an exemplary block diagram showing an example of an internal configuration of a motion vector detecting unit in the embodiment;

FIG. 3 is an exemplary perspective view showing two image frames and an interpolation frame to which a motion vector detecting procedure according to an embodiment of the invention is applied in the embodiment;

FIG. 4 is an exemplary flowchart showing an operation procedure of an interpolation frame creation processing in the interpolation frame creating apparatus in the embodiment;

FIG. 5 is an exemplary diagram schematically showing portions including repeating images having different motion characteristics in an image frame together with a joined macroblock in the embodiment;

FIG. 6 is an exemplary diagram schematically showing portions including repeating images having different motion characteristics in an image frame, the repeating images being other than those in FIG. 5 in the embodiment;

FIG. 7 is an exemplary diagram schematically showing a SAD distribution of a macroblock including a repeating image in the embodiment;

FIG. 8 is an exemplary diagram schematically showing a SAD distribution of another macroblock including a repeating image having the same motion characteristic as that in FIG. 7 in the embodiment;

FIG. 9 is an exemplary diagram schematically showing a SAD distribution of a macroblock including a repeating image having a different motion characteristic from that in FIG. 7 in the embodiment;

FIG. 10 is an exemplary diagram schematically showing a SAD distribution of another macroblock including a repeating image having a different motion characteristic as that in FIG. 7 in the embodiment; and

FIG. 11 is an exemplary diagram schematically showing portions including repeating images having different motion characteristics in an image frame together with a conventional range in which macroblocks are jointed in the embodiment.

### DETAILED DESCRIPTION

Various embodiments according to the invention will be described hereinafter with reference to the accompanying drawings. In general, according to one embodiment of the invention, a motion vector detecting apparatus performs block matching of a plurality of image frames to detect a motion vector. The motion vector detecting apparatus has a macroblock joining section forming a joined macroblock in which a plurality of macroblocks including repeating images among macroblocks being subjects of the block matching are joined by every motion characteristic of the repeating image included in each macroblock.

Further, in a motion vector detecting method, block matching of a plurality of image frames is performed to detect a motion vector. In the motion vector detecting method, it is formed a joined macroblock in which a plurality of macroblocks including repeating images among macroblocks being subjects of the block matching are joined by every motion characteristic of the repeating image included in each macroblock, and the motion vector is detected using the joined macroblock.

Further, an interpolation frame creating apparatus has a motion vector detecting section performing block matching of a plurality of image frames to detect a motion vector and an interpolation frame creating section creating an interpolation frame to be interpolated between the respective image frames based on the motion vector detected by the motion vector detecting section. The motion vector detecting section has a macroblock joining section forming a joined macroblock in which a plurality of macroblocks including repeating images among macroblocks being subjects of the block matching are joined by every motion characteristic of the repeating image included in each macroblock.

### (Configuration of Interpolation Frame Creating Apparatus)

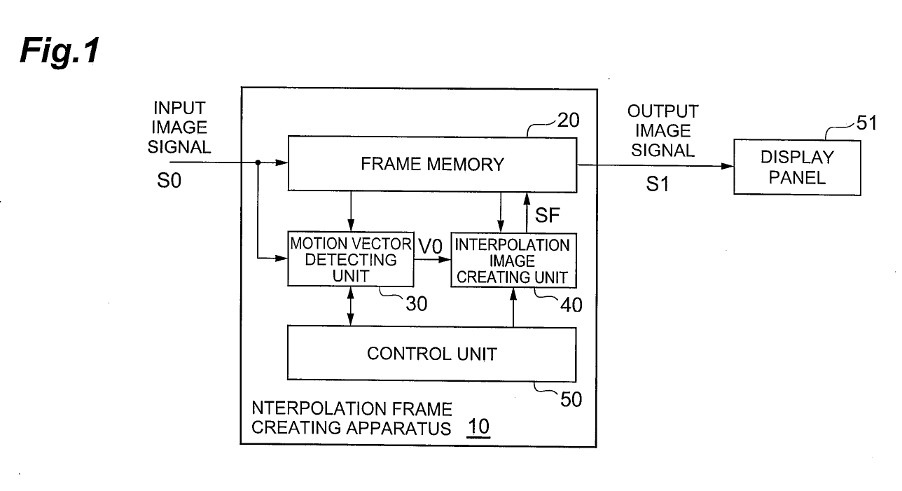

FIG. 1 is a block diagram showing a configuration of an interpolation frame creating apparatus 10 according to an embodiment of the invention. This interpolation frame creating apparatus 10 is provided in an apparatus having an image display function such as television, personal computer, and portable telephone.

This interpolation frame creating apparatus 10 creates, from a plurality of image frames constituting an inputted input image signal S0 (60 F/s), an interpolation frame interpolating the plurality of image frames, and outputs an output image signal S1 (120 F/s) in which the created interpolation frame is outputted to a display panel 51.

The interpolation frame creating apparatus 10 has a frame memory 20, a motion vector detecting unit 30, an interpolation image creating unit 40, and a control unit 50.

The frame memory 20 stores the input image signal S0 by every image frame. The motion vector detecting unit 30 performs block matching for an image frame inputted without intervention of the frame memory 20 and an image frame stored in the frame memory 20 to detect a motion vector V0, and outputs the detected motion vector V0 to the interpolation image creating unit 40. Note that a configuration and operation contents of the motion vector detecting unit 30 will be described in detail later.

The interpolation image creating unit 40 creates an interpolation frame SF based on the image frame inputted without intervention of the frame memory 20 and the image frame stored in the frame memory 20 and the detected motion vector V0, and stores the created interpolation frame SF in the frame memory 20. The operation of this interpolation image creating unit 40 will also be described in detail later. The control unit 50 outputs a later-described block timing signal BT to the motion vector detecting unit 30 and so on to control the creation of the interpolation frame.

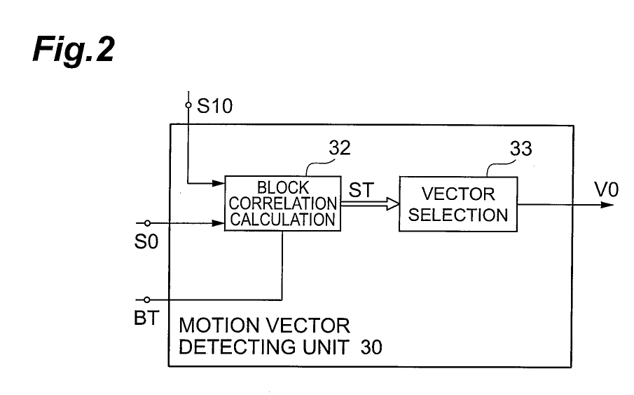

Next, the configuration of the motion vector detecting unit 30 will be described with reference to FIG. 2. FIG. 2 is a block diagram showing a configuration as an example of the motion vector detecting unit 30.

The motion vector detecting unit 30 has a block correlation calculating unit 32 and a vector selecting unit 33 as shown in FIG. 2.

The block correlation calculating unit 32 inputs the input image signal S0 and a one-frame delay signal S10, which is inputted from the frame memory 20. Then, according to timing indicated by the block timing signal BT supplied from the control unit 50, the block correlation calculating unit 32 performs block matching with two image frames being subjects, the two image frames constituting the input image signal S0 and the one-frame delay signal S10 respectively, and outputs a correlation signal ST showing a correlation between respective blocks. The correlation signal ST is outputted to the vector selecting unit 33.

This block correlation calculating unit 32 has a macroblock joining section forming a joined macroblock by performing later-described macroblock joining.

Based on the inputted correlation signal ST, the vector selecting unit 33 detects a vector value showing displacement between blocks having a highest correlation, and outputs the motion vector V0 based on the detected vector value.

Here, in the block correlation calculating unit 32 and the vector selecting unit 33, SAD (Sum of Absolute Difference of pixels) between respective blocks in a moving direction as candidates is used as the correlation signal ST. Further, the vector selecting unit 33 judges that a block having a smallest value of this SAD as a block having a highest correlation.

### (Operation Contents of the Interpolation Frame Creating Apparatus)

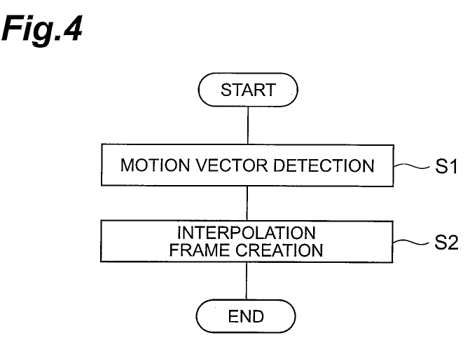

Next, operation contents of the interpolation frame creating apparatus 10 will be described. The interpolation frame creating apparatus 10 performs interpolation frame creation processing in accordance with a flowchart shown in FIG. 4 to create an interpolation frame.

When starting the interpolation frame creation processing, the interpolation frame creating apparatus 10 performs motion vector detection (S1), and performs interpolation frame creation in subsequent S2. When the interpolation frame is created, the control unit 50 performs an operation as an image signal output section to output an output image signal to the display panel 51.

In the motion vector detection, the motion vector detecting unit 30 performs block matching of two image frames to detect a motion vector.

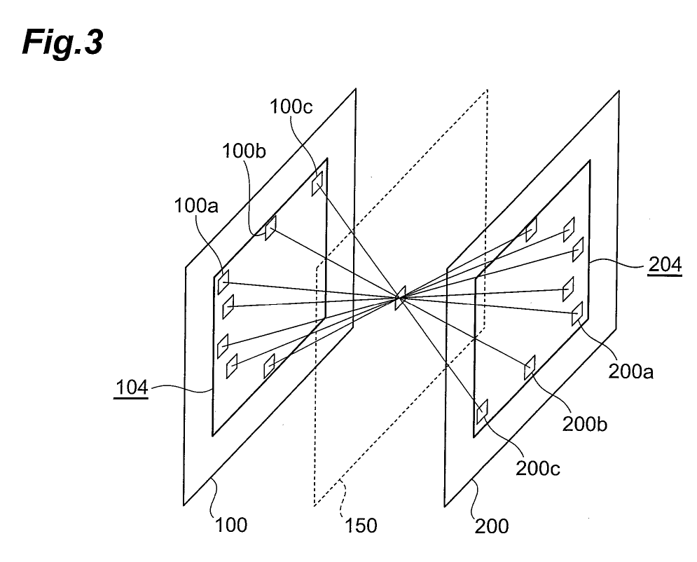

In this case, in the block correlation calculating unit 32, the block matching is performed with an image frame (previous frame) 100 constituting the input image signal S0 and an image frame (subsequent frame) 200 constituting the one-frame delay signal S10 being subjects, as shown in FIG. 3.

In this block matching, the previous frame 100 positioned temporally previously and the subsequent frame 200 positioned temporally subsequently are each divided into a plurality of macroblocks, according to timing indicated by the block timing signal BT.

In the embodiment, as shown in FIG. 3, the previous frame 100 is divided into a plurality of macroblocks including macroblocks 100a, 100b, 100c and the subsequent frame 200 is divided into a plurality of image blocks including macroblocks 200a, 200b, 100c.

Thereafter, for the previous frame 100 and the subsequent frame 200, a correlation between respective image blocks (for example, a correlation between the macroblock 100a and the macroblock 200a) is detected in respective search. areas 104, 204, and the correlation signal ST is outputted.

Then, in the interpolation frame creating apparatus 10, when the block correlation calculating unit 32 performs block matching as described above, sometimes a repeating image may be included in the macroblock to be a subject of the block matching.

The repeating image is an image in which a plurality of quite similar images are included and an image in which the quite similar images are repeatedly displayed when displayed in the display panel 51, such as, for example, a striped pattern of a zebra and a lattice pattern.

when a correlation between macroblocks including such repeating images is obtained, sometimes only a repeating component (that is, an individual quite similar image, for example, part of the striped pattern of the zebra) is included instead of the entire repeating image in the macroblock.

In such a case, for example, when the correlation between the macroblock 100a of the previous frame 100 and the macroblock 200a of the subsequent frame 200 is obtained, which parts in the respective repeating images are compared becomes unobvious.

Therefore, whether or not the repeating images have moved is unobvious, so that an accurate motion vector cannot be detected.

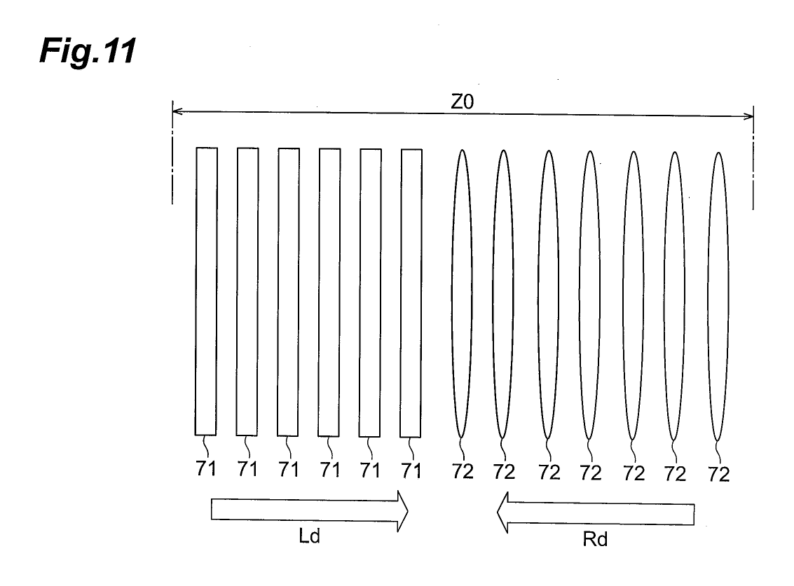

Accordingly, when the correlation between the macroblocks including the repeating images is obtained, the block matching is performed using macroblocks including the entire repeating images. In this case, for example, as shown in FIG. 11, when there is an image in which a plurality of long rectangular bar-shaped images 71 and a plurality of bar-shaped images 72 whose both ends are curved are included, one macroblock is formed by putting neighboring macroblocks together as far as the entire bar-shaped images 71 and bar-shaped images 72 can be covered (in a rage of Z0), and then the block matching is performed.

Whether or not the repeating image is included in the macroblock is judged by whether or not a plurality of minimum points exist in each SAD distribution in each macroblock. When the plurality of minimum points exist, the image is judged to be a repeating image and one macroblock is formed.

Then, as shown in FIG. 11, with a motion direction of the bar-shaped images 71 being defined as a right direction Ld and a motion direction of the bar-shaped images 72 being defined as a left direction Rd, even when motion characteristics of respective repeating images are different, the repeating images of both are put together to form the macroblock.

However, if the macroblock is formed in such a manner, since the repeating images having different motion characteristics of the components (bar-shaped images 71) moving in the right direction Ld and the components (bar-shaped images 72) moving in the left direction Rd are mixed in one macroblock, it become impossible to obtain a motion vector accurately.

Thus, in the interpolation frame creating apparatus 10 according to the embodiment, a joined macroblock is formed as follows.

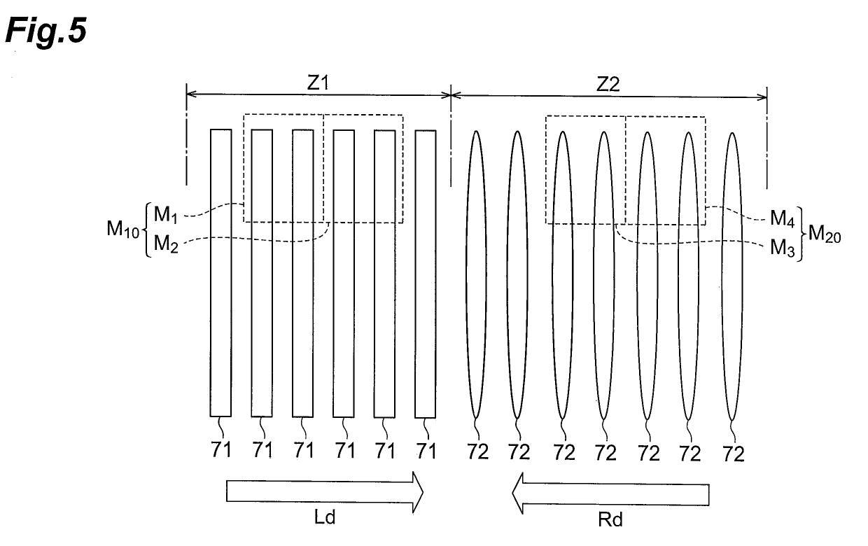

Here, FIG. 5 is a diagram schematically showing portions including repeating images having different motion characteristics in an image frame together with a joined macroblock.

The block correlation calculating unit 32 according to the embodiment performs for a plurality of macroblocks M1, M2, M3, M4 including repeating images, block joining to join the macroblocks by every motion characteristic of the repeating image included in each macroblock to form joined macroblocks M10, M20. Here, the macroblocks M1, M2 are images including the bar-shaped images 71, while the macroblocks M3, M4 are images including the bar-shaped images 72.

Then, during a period in which repeating components appear, the block correlation calculating unit 32 performs an operation as a motion characteristic detecting section to detect a motion characteristic such as a moving direction and a moving speed of each repeating component from a later-described SAD distribution, and based on a detection result, judges a group whose SAD distributions are close to each other as an repeating image having the same motion characteristic, and forms the joined macroblocks M10, M20.

In a case of FIG. 5, since the motion characteristic of the bar-shaped images 71 is the right direction Ld and the motion characteristic of the bar-shaped images 72 is the left direction Ld, the block correlation calculating unit 32 divides a range for putting the macroblocks together into ranges Z1, Z2 and joins the macroblocks M1 and M2 and the macroblocks M3 and M4 in the respective ranges to form the joined macroblocks M10, M20.

In the joined macroblocks M10, M20 formed as above, only the repeating images having the same motion characteristics are included and the repeating images having different moving characteristics are not included. Therefore, accuracy in which the motion vector is found in the motion vector detecting unit 30 is improved, so that an accurate motion vector can be detected.

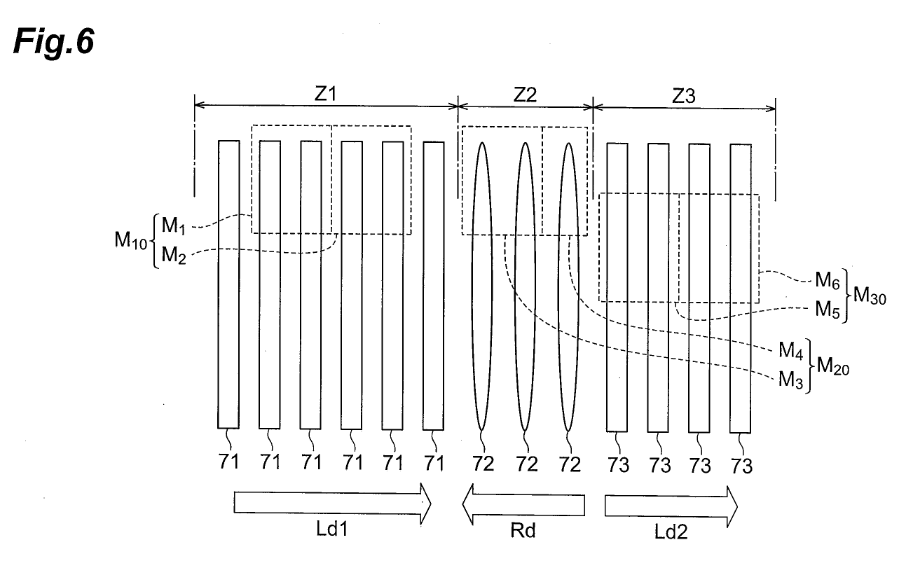

FIG. 6 is a diagram schematically showing portions including repeating images having different motion characteristics in an image frame, the repeating images being other than those in FIG. 5. In FIG. 6 a scene is supposed in which a lattice shape exists as a background and an object (for example, a zebra) having a repeating image is crossing in front thereof.

As described above, since the block correlation calculating unit 32 joins the macroblocks by every motion characteristic of the repeating image to form the joined macroblock, the block correlation calculating unit 32 divides the range for putting the macroblocks together into the ranges Z1, Z2, Z3 and performs the block joining. Then, the block correlation calculating unit 32 joins the macroblocks M1 and M2, the macroblocks M3 and M4, the macroblocks M5 and M6 respectively in the ranges Z1, Z2, Z3 to form joined macroblocks M10, M20, M30.

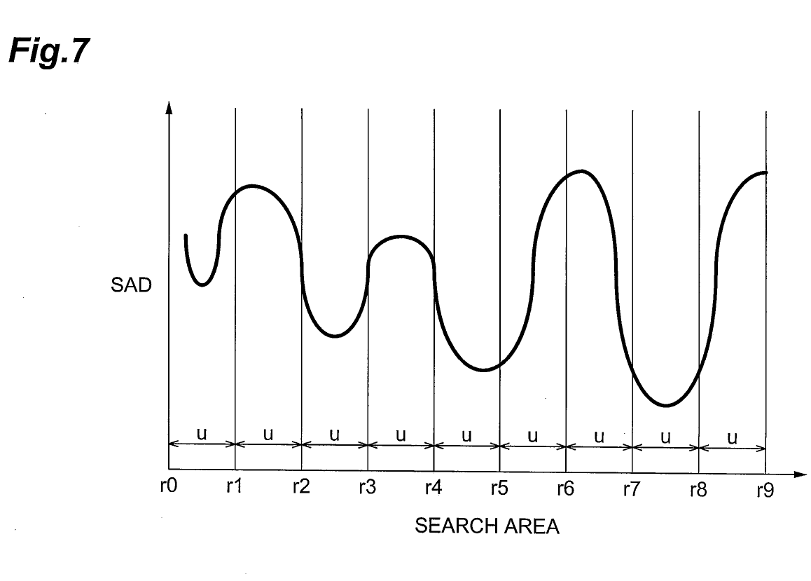

Meanwhile, during a period in which repeating components appear, the block correlation calculating unit 32 detects a moving characteristic, such as a moving direction and a moving speed of each repeating component from a later-described SAD distribution. This will be described with reference to FIG. 7 to FIG. 10.

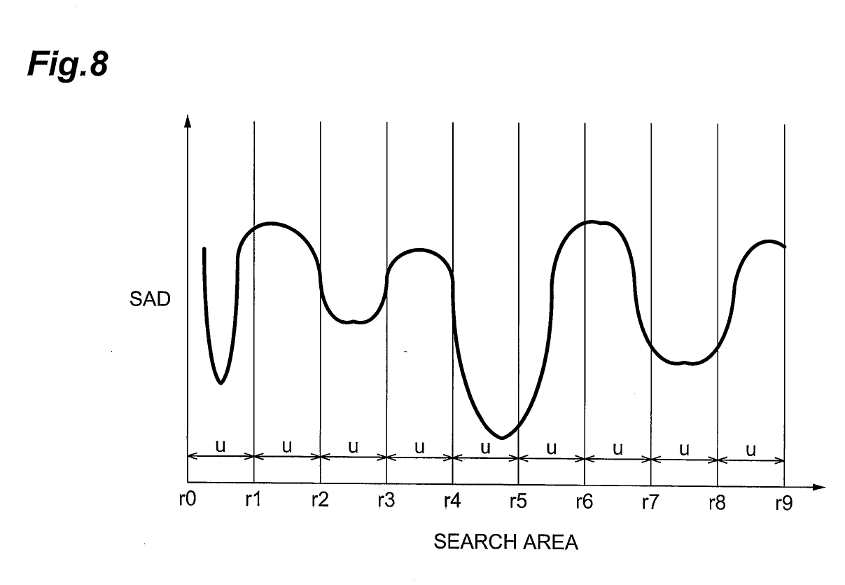

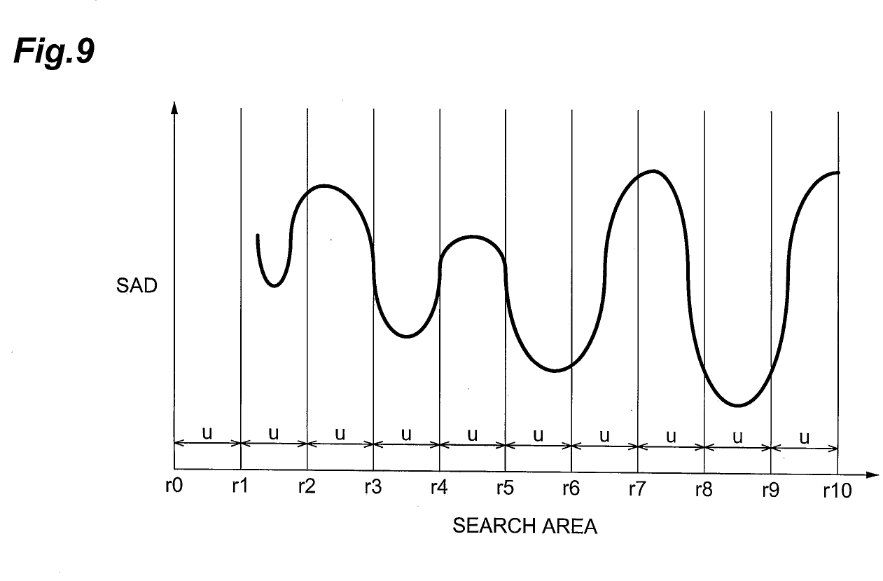

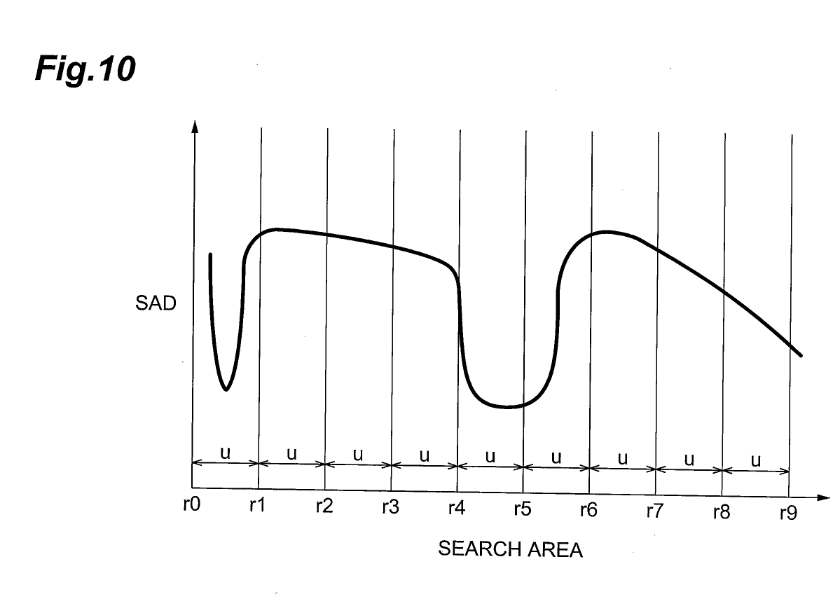

FIG. 7 and FIG. 8 are diagrams showing SAD distributions of different macroblocks, FIG. 7 showing the SAD distribution of macroblock M1 and FIG. 8 showing the SAD distribution of the macroblock M2. FIG. 9 and FIG. 10 are diagrams showing SAD distributions of macroblocks including repeating images having different motion characteristics from those in FIG. 7 and FIG. 8, FIG. 9 showing the SAD distribution of the macroblock M5 and FIG. 10 showing the SAD distribution of the macroblock M3.

The block correlation calculating unit 32 detects the motion characteristic of the repeating image included in each macroblock as follows.

The block correlation calculating unit 32 first performs an operation as a dividing section and divides each SAD distribution into a plurality of sections having equal intervals u as shown in the diagram. Then, the block correlation calculating unit 32 determines a section in which a minimum value of SAD in the respective sections exists. If the minimum values of SAD exist in the same section, it is judged that the SAD distributions are close to each other and motion components of the repeating images coincide with each other. If the minimum values of SAD do not exist in the same section, it is judged that the motion components of the repeating images do not coincide with each other.

For example, though the SAD distributions shown in FIG. 7 and FIG. 8 are different in sizes of the respective minimum values, the minimum values exist in the same sections r0-r1, r2-r3, r4-r5, r7-r8. Therefore, the block correlation calculating unit 32 judges that in the macroblocks showing the SAD distributions in FIG. 7 and FIG. 8, respective SAD distributions are close to each other and the motion components of the repeating images are the same, and then joins these macroblocks.

In contrast, in a case of the SAD distribution shown in FIG. 9, though the minimum values coincide with those of the SAD distribution in FIG. 7, the minimum values exist in different sections. In other words, in the SAD distribution shown in FIG. 9, the minimum values exist in the sections r1-r2, r3-r4, r5-r6, r8-r9. Thus, the block correlation calculating unit 32 judges that the macroblock showing the SAD distribution in FIG. 9 is different from the macroblock in FIG. 7 in terms of the SAD distribution and the motion characteristic of the repeating image is different, and then joins macroblocks separately from the macroblock in FIG. 7.

Regarding FIG. 10, since both the minimum values and the sections in which the minimum values exist are different, it is judged, also in this case, that the SAD distribution is different from that of the macroblock in FIG. 7 and the motion characteristic of the repeating image is different, and macroblocks are joined separately from the macroblock in FIG. 7.

As stated above, the block correlation calculating unit 32 detects the motion characteristic of the repeating images from the SAD distribution. This is because regularity of repeating components constituting the repeating image appears in the SAD distribution.

When SAD distributions of a plurality of macroblocks are compared, in SAD distributions of the macroblocks including similar repeating images such as the macroblock M1 and the macroblock M2, though sizes themselves of the minimum values may be different due to a noise and the like in processing, sizes of repeating components or intervals of their appearance are reflected to appearance of minimum values. Therefore, appearance characteristics of the minimum values such as intervals and number of times of appearance of the minimum values coincide with each other.

Therefore, the block correlation calculating unit 32 divides the SAD distribution into the plurality of equal sections as described above, determines the sections in which the minimum values exist among the respective sections, judges whether or not the sections coincide with each other, and based on a judgment result, forms a joined macroblock.

In this case, in judging by the block correlation calculating unit 32 of identity of minimum value distributions in the SAD distributions described above, not only perfect coincidence but also redundancy such as 80% coincidence and 60% coincidence can be allowed.

By forming the joined macroblock as described above and detecting the motion vector using the joined macroblock, accurate motion vector search becomes possible for consecutive, repeating images which move in different directions.

When the correlation signal ST is outputted from the block correlation calculating unit 32 as described above, the vector selecting unit 33 detects a vector value showing displacement between blocks having a highest correlation between respective blocks based on the correlation signal ST, and then outputs the motion vector V0.

Subsequently, based on the motion vector V0 outputted from the motion vector detecting unit 30, the interpolation image creating unit 40 creates in the following manner an interpolation frame 150 which is to be interpolated between the previous frame (reference frame) 100 inputted without intervention of the frame memory 20 and the subsequent frame (standard frame, detection subject frame) 200 stored in the frame memory 20.

The interpolation image creating unit 40 determines temporal distances between respective pixel blocks in the previous frame 100 and respective pixel blocks in the subsequent frame 200, and reduces the motion vector V0 by the ratio of a temporal distance from the previous frame 200 to the interpolation frame 150 in the determined temporal distances.

Then, the interpolation image creating unit 40 makes displacement of corresponding pixel blocks in the subsequent frame 200 based on the reduced motion vector V0 to generate blocks constituting the interpolation frame 150. The interpolation image creating unit 40 repeats this procedure for each of the pixel blocks in the previous frame 100 and each of the pixel blocks in the subsequent frame 200 to thereby create the interpolation frame 150.

The above explanation is for explaining the embodiments of the invention, and not to limit the apparatus and the method of the invention, and various modification examples thereof can be implemented easily. Also, any apparatus or method constructed by appropriately combining the components, functions, characteristics or method blocks in the respective embodiments are included in the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A motion vector detecting apparatus performing block matching of a plurality of image frames to detect a motion vector, comprising
a macroblock joining section forming a joined macroblock in which a plurality of macroblocks including repeating images among macroblocks being subjects of the block matching are joined by every motion characteristic of the repeating image included in each macroblock.

2. The motion vector detecting apparatus according to claim 1, further comprising
a motion characteristic detecting section detecting the motion characteristic of the repeating image included in the each macroblock, wherein
said macroblock joining section forms the joined macroblock based on a detection result of said motion characteristic detecting section.

3. The motion vector detecting apparatus according to claim 2, wherein
said motion characteristic detecting section detects the motion characteristic from a SAD distribution of the repeating image.

4. The motion vector detecting apparatus according to claim 1, further comprising:
a motion characteristic detecting section detecting the motion characteristic from a SAD distribution of the repeating image included in the each macroblock; and
a dividing section dividing the SAD distribution detected by said motion characteristic detecting section into a plurality of sections having equal intervals, wherein
said macroblock joining section forms the joined macroblock when minimum point sections among the respective sections divided by said dividing section are different, in the minimum point sections minimum points in the SAD distributions existing.

5. A motion vector detecting method of performing block matching of a plurality of image frames to detect a motion vector, comprising:
forming a joined macroblock in which a plurality of macroblocks including repeating images among macroblocks being subjects of the block matching are joined by every motion characteristic of the repeating image included in each macroblock; and
detecting the motion vector using the joined macroblock.

6. An interpolation frame creating apparatus comprising a motion vector detecting section performing block matching of a plurality of image frames to detect a motion vector and an interpolation frame creating section creating an interpolation frame to be interpolated between the respective image frames based on the motion vector detected by said motion vector detecting section,
said motion vector detecting section comprising a macroblock joining section forming a joined macroblock in which a plurality of macroblocks including repeating images among macroblocks being subjects of the block matching are joined by every motion characteristic of the repeating image included in each macroblock.

7. The interpolation frame creating apparatus according to claim 6, wherein
among the image frames, when the image frame as a subject of detection of the motion vector by said motion vector detecting section is defined as a detection subject frame, and the image frame to be referred to when detecting the motion vector is defined as a reference frame, said interpolation frame creating section makes displacement of the detection subject frame based on the motion vector detected by said motion vector detecting section to create the interpolation frame.

8. The interpolation frame creating apparatus according to claim 6, further comprising
a frame memory storing the detection subject frame, wherein
said motion vector detecting section divides the detection subject frame stored in said frame memory and the reference frame into a plurality of image blocks, and performs the block matching for each of the divided image blocks to detect the motion vector.

9. The interpolation frame creating apparatus according to claim 6, further comprising
an image signal outputting section outputting an output image signal including the interpolation frame to a display panel.
